(19) United States
(12) Patent Application Publication
(10) Pub. No.: US 2013/0017331 A1
(43) Pub. Date: Jan. 17, 2013

(54) Faux Finish and Process for Applying and Creating a Faux Finish

(71) Applicant: Raymond Sandor, Vero Beach, FL (US)

(72) Inventor: Raymond Sandor, Vero Beach, FL (US)

(21) Appl. No.: 13/181,008

(22) Filed: Jul. 12, 2011

(51) Int. Cl. B05D 5/00; C09D 133/08

(52) U.S. Cl. 427/267; 524/35

(57) ABSTRACT

A process for applying a faux finish includes the steps of applying a textured paint to a surface as a base coat, the textured paint having approximately 250 grams to approximately 500 grams of pumice per liquid gallon of paint, allowing the applied textured paint to dry on the surface, randomly applying to the dried textured paint a wet slurry composition, partially drying the applied wet composition, and dry brushing the partially dried composition about the dried textured paint to create a faux effect on the surface. The wet slurry composition comprises concentrations of approximately 40% to approximately 70% by volume of water, approximately 0.2% to approximately 0.5% by volume of methylcellulose, approximately 15% to approximately 25% by volume of acrylic resin, and approximately 15% to approximately 25% by volume of mica particles having a mesh size of between approximately 250 mesh and approximately 400 mesh.

### STATEMENT REGARDING FEDERALLY SPONSORED RESEARCH OR DEVELOPMENT

Not Applicable

### FIELD OF THE INVENTION

The present invention lies in the field of faux finishes. The present disclosure relates to a faux finish having natural and colored reflective particles in an acrylic slurry paint to produce decorative finishes over a finely textured base-coat and processes and methods for applying the paint to create a faux finish.

### BACKGROUND OF THE INVENTION

Particles of mica (in the group of sheet silicate (phyllosilicate) minerals), in general, have been used to produce reflective particle finishes and decorations. Mica includes the commonly known natural glitters. Such particulates are rated in industry sizes, generally referred to as a mesh size (e.g., 200-mesh screen). One company, Micro Powders, Inc., uses mica and polyethylene for non-skid deck paint for boats.

In such finishes, mica particles are mixed into paints and applied to a substrate, thereby producing a sparkle-type finish. To keep the distribution of mica particles uniform, such a mixture is generally applied by a spray or roll-on application. Dry mica particles have also been applied by sprinkling onto a wet paint or wet glue surface, which produces a very uneven partial distribution having a decorative affect.

The use of mica as described, however, is not able to produce different textured and colored finishes or finishes that can be manipulated over a period of time to create varying textures and colors across a decorative surface.

Thus, a need exists to overcome the problems with the prior art systems, designs, and processes as discussed above.

### SUMMARY OF THE INVENTION

The invention provides a faux finish and process for applying and creating a faux finish that overcomes the hereinafore-mentioned disadvantages of the heretofore-known devices and methods of this general type and that provide such features with a reflective decorative finish and visual and textural affects never produced before.

The invention provides a novel paint system including a carrier of mica particles applied to a gritty substrate including pumice and a system and process for applying this novel paint to manipulate the particles after application.

A paint-type carrier or base coat is applied first. The base coat must dry with a gritty, “non-skid” surface. Accordingly, pumice particles are added to the base coat. Pumice is a natural substance and is made from volcanic ash. In the industry, pumice is measured in particle sizes, for example, as 1F, 2F, and 4F. The inventive process has the pumice-including paint applied to the surface to receive the novel textured coat. After drying, the surface is gritty as sandpaper, for example.

The novel second coat is applied. The second coat is a transparent, slippery slurry comprising water, methylcellulose, acrylic resin and mica particles (dry or liquid colorants can be added if desired). The slurry is allowed to partially dry. Using what is referred to in the art as a dry brush technique, the partially dry slurry is randomly moved about on the base coat. A “dry brush out” technique is a common painter's term where a material substantially does not stick to the dry brush being used. The dry brush technique can use foam brushes and/or fine “Chinese” bristle brushes. The pumice particles held in the base coat provide uneven hills and valleys that act as obstructions to the mica particles in the second coat while they are being randomly moved about. The mica particles have sharp edges and, therefore, tend to pile up due to the nooks and crannies provided by the pumice in the base coat. Consequently, the mica particles gather in areas of high concentration and low concentration to form lines and piles that, when, finally dried, produce a finish that has not been possible before.

With the foregoing and other objects in view, there is provided, in accordance with the invention, a process for applying a faux finish including the steps of applying a textured paint to a surface as a base coat, the textured paint having approximately 250 grams to approximately 500 grams of pumice per liquid gallon of paint, allowing the applied textured paint to dry on the surface, randomly applying to the dried textured paint a wet slurry composition comprising concentrations of:

approximately 40% to approximately 70% by volume of water;

approximately 0.2% to approximately 0.5% by volume of methylcellulose;

approximately 15% to approximately 25% by volume of acrylic resin; and

approximately 15% to approximately 25% by volume of mica particles having a mesh

size of between approximately 250 mesh and approximately 400 mesh; partially drying the applied wet composition, and dry brushing the partially dried composition about the dried textured paint to create a faux effect on the surface.

With the objects of the invention in view, there is also provided a faux finish material including a slurry composition comprising concentrations of:

approximately 40% to approximately 70% by volume of water;

approximately 0.2% to approximately 0.5% by volume of methylcellulose;

approximately 15% to approximately 25% by volume of acrylic resin; and

approximately 15% to approximately 25% by volume of mica particles having a mesh

size of between approximately 250 mesh and approximately 400 mesh.

With the objects of the invention in view, there is also provided a faux finish including a textured paint having approximately 250 grams to approximately 500 grams of pumice per liquid gallon of paint and a slurry composition comprising concentrations of:

approximately 40% to approximately 70% by volume of water;

approximately 0.2% to approximately 0.5% by volume of methylcellulose;

approximately 15% to approximately 25% by volume of acrylic resin; and

approximately 15% to approximately 25% by volume of mica particles having a mesh

size of between approximately 250 and approximately 400 mesh, the composition being applied wet to the textured paint after the textured paint dries on a surface.

In accordance with another mode of the invention, there is provided the step of adding to the wet composition a concentration of approximately 5% to approximately 30% by volume of colorant.

In accordance with a further mode of the invention, the mica particles gather in textured areas of the textured paint when the partially dried composition is dry brushed.

In accordance with an added mode of the invention,

In accordance with a concomitant mode of the invention, the composition, after partially drying, is dry brushed about the textured paint.

Although the invention is illustrated and described herein as embodied in a faux finish and process for applying and creating a faux finish, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a flow chart of an exemplary process for applying a finish according to the invention; and

FIG. 2 is a flow chart of an exemplary process for creating a faux finish slurry according to the invention.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

Described now are exemplary embodiments of the present invention.

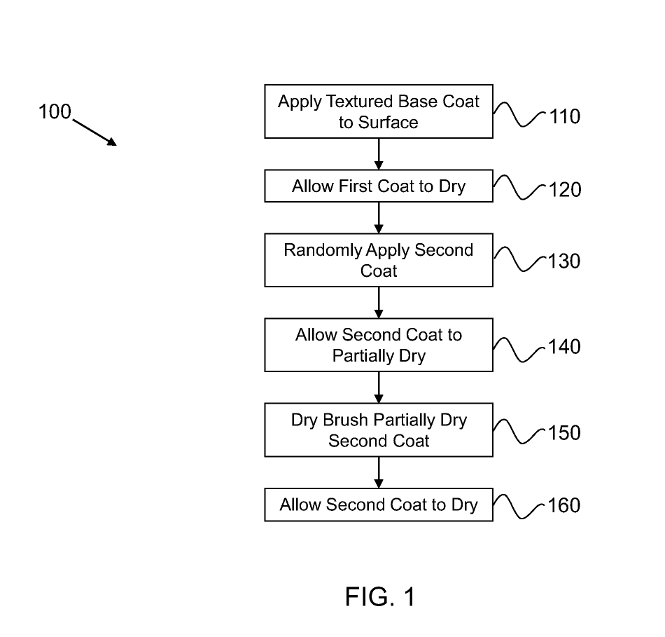

FIG. 1 illustrates an exemplary embodiment of a process 100 for applying the inventive faux finish according to the invention. The surface on which the novel faux finish will rest must have a texture. Accordingly, in a first painting Step 110, a textured base coat is applied to the surface. One exemplary base coat is formed from mixing pumice particles into a standard paint. The pumice has a particle size including 1F, 2F, and 4F. This pumice is added to the paint in an amount of between approximately 250 grams to approximately 500 grams per liquid gallon of paint. In an exemplary embodiment, approximately 320 grams is added per liquid gallon of paint. When dry, in Step 120, the base coat has a texture similar to sandpaper having between 100 and 400 grit size, preferably, approximately about 200 grit size.

The novel second coat is randomly applied in Step 130 by brush, spray, and/or roller.

The second coat is a transparent, slippery slurry comprising water, methylcellulose, acrylic resin, and mica particles (but colorants can be added if desired). The slurry must be slippery so that it does not have too much friction to prevent the ability to spread the slurry about the base-coat-painted surface, but, at the same time, must be somewhat tacky or have enough weight to not easily slide off the base-coat-painted surface.

The slurry is allowed to partially dry in Step 140. The partial drying occurs between approximately 10 and approximately 20 minutes. In an exemplary embodiment, the partial drying occurs in approximately 15 minutes. In terms of visual painting techniques, “partially dry” as used herein occurs when the surface looks approximately half-dull (drier) and approximately half-shiny (wetter).

Using what is referred to in the art as a dry brush technique, the partially dry slurry is randomly moved about on the base coat in Step 150 and is allowed to dry in Step 160. The pumice particles provide uneven hills and valleys that act as obstructions to the mica particles in the second coat as they are randomly moved about on the base coat. The mica particles have sharp edges and, therefore, tend to pile up on themselves to create a “shark-skin” physical affect due to the nooks and crannies provided by the pumice in the base coat. Consequently, the mica particles gather in areas of high concentration and low concentration to form lines and piles that, when, finally dried, produce a finish that has not been possible before.

The dry brush randomly moves about the mica particles to allow them to pile-up on the “more dry” portions of the base coat substrate. Because of the friction provided by the fine textured base coat surface, the semi-dry state of the slurry allows the mica particles in the mixture to randomly slide about the surface but to not slide too much—it does not slide entirely off the base coated surface. The mica particles cannot be too fine or they will not build-up. Therefore, the mica particles are selected to be between approximately 300 mesh and approximately 400 mesh.

When colorants are added, they are freely suspended in the finish system and are very fine as compared to the mica particles. With color and the mica slurry being in the semi-dry state or the wet state, the color moves about at a different rate than the mica particles due to the higher friction rate of the mica particles on the fine textured surface as compared to the color. This imbalance results in color concentrations residing along the randomly build-up areas of the mica particles. Because the colorant is so fine, it not only gathers up on build-up-lines/piles of mica, but it also flows into all of the surface in varying degrees to overtone the whole finish, with the strongest color existing near the mica build-up areas.

The slurry comprises a liquid composition having the following concentrations of components by volume:

40% to 70% of water;

0.2% to 0.5% of methylcellulose;

15% to 25% of acrylic resin; and

15% to 25% of mica particles having a mesh size of between

approximately 250 mesh and approximately 400 mesh; and

if desired, 5% to 30% of color.

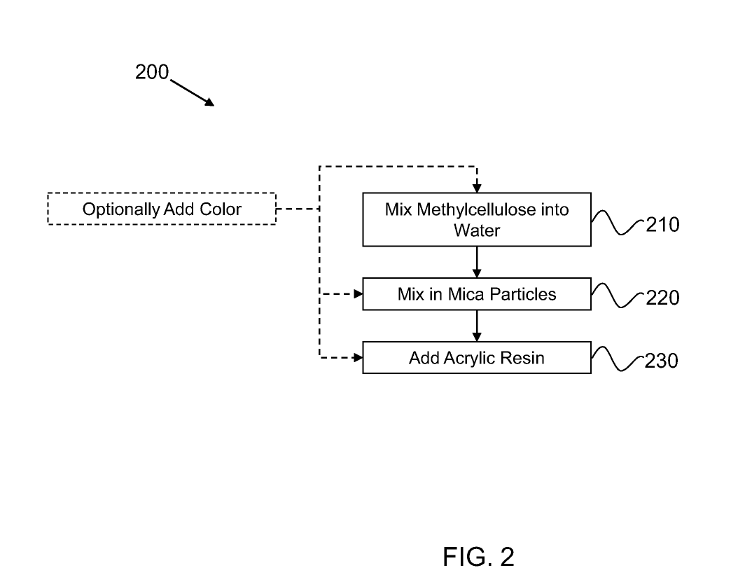

FIG. 2 illustrates an exemplary embodiment of a process for creating the second coat slurry composition. In Step 210, the methylcellulose is mixed into the water. In Step 220, the mica particles are added to the composition. The acrylic resin is added to the composition in Step 230. If desired, the colorant is added in the desired amount at any time during, before, or after any of Steps 210, 220, and 230.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A process for applying a faux finish, which comprises:
applying a textured paint to a surface as a base coat, the textured paint having approximately 250 grams to approximately 500 grams of pumice per liquid gallon of paint;
allowing the applied textured paint to dry on the surface;
randomly applying to the dried textured paint a wet slurry composition comprising concentrations of:
approximately 40% to approximately 70% by volume of water;
approximately 0.2% to approximately 0.5% by volume of methylcellulose;
approximately 15% to approximately 25% by volume of acrylic resin; and
approximately 15% to approximately 25% by volume of mica particles having a mesh size of between approximately 250 mesh and approximately 400 mesh;
partially drying the applied wet composition; and
dry brushing the partially dried composition about the dried textured paint to create a faux effect on the surface.

2. The process according to claim 1, further comprising adding to the wet composition a concentration of approximately 5% to approximately 30% by volume of colorant.

3. The process according to claim 1, wherein the mica particles gather in textured areas of the textured paint when the partially dried composition is dry brushed.

4. A faux finish material, comprising:
a slurry composition comprising concentrations of:
approximately 40% to approximately 70% by volume of water;
approximately 0.2% to approximately 0.5% by volume of methylcellulose;
approximately 15% to approximately 25% by volume of acrylic resin; and
approximately 15% to approximately 25% by volume of mica particles having a mesh size of between approximately 250 mesh and approximately 400 mesh.

5. A faux finish, comprising:
a textured paint having approximately 250 grams to approximately 500 grams of pumice per liquid gallon of paint; and
a slurry composition comprising concentrations of:
approximately 40% to approximately 70% by volume of water;
approximately 0.2% to approximately 0.5% by volume of methylcellulose;
approximately 15% to approximately 25% by volume of acrylic resin; and
approximately 15% to approximately 25% by volume of mica particles having a mesh size of between approximately 250 and approximately 400 mesh,
the composition being applied wet to the textured paint after the textured paint dries on a surface.

6. The finish according to claim 5, wherein the composition, after partially drying, is dry brushed about the textured paint.

7. The finish according to claim 6, wherein the mica particles gather in textured areas of the textured paint when the partially dried composition is dry brushed.
